(19) United States
(12) Patent Application Publication
(10) Pub. No.: US 2011/0218043 A1
(43) Pub. Date: Sep. 8, 2011

(54) Sports video game controller

(76) Inventor: Howard Ellis Quillen, III, Houston, TX (US)

(21) Appl. No.: 13/065,309

(22) Filed: Mar. 19, 2011

Related U.S. Application Data
(63) Continuation-in-part of application No. 11/983,395, filed on Nov. 9, 2007, now abandoned.

(51) Int. Cl. A63F 13/06

(52) U.S. Cl. 463/37; 463/39

(57) ABSTRACT

An apparatus is provided for controlling a video sports game, the apparatus capable of allowing the person playing a sports game to remove the games playbook from the primary display to a secondary display affixed to the gaming controller without interfering with the normal display of the game-world view. Another display may be attached to the players arm with the use of a wristband or sleeve, which will allow the player to have visual access to his available plays and alternative plays, also commonly known as an “audible”. The controller, the affixed display, and the wristband or sleeve controller are electrically or wirelessly connected with a game host via the control unit and an interface, whereby, the controllers allows the games plays and audible plays to be viewed and selected without an opponent being able to see which play are being called.

### CROSS REFERENCE TO RELATED APPLICATION

This application is a continuation-in-part of U.S. patent application Ser. No. 11/983,395, filed Nov. 9, 2007, entitled “Ultimate Football Joystick,” all of which is herein incorporated by reference.

### BACKGROUND OF THE INVENTION

1. Field of the Invention

The present invention is related to a game controller for a video game, and more particularly to game controllers with monitors that allow the selection of game options by a player(s), out of the view of the opposing player(s).

2. Description of the Related Art

Video game systems have become extremely popular in recent years, particularly the systems designed for home use. These video game systems typically include a console containing a power supply, CPU, and software for operating the console. The console typically includes an interface for reading a storage medium (e.g., a CD-ROM) containing the software for a particular game, a video interface for coupling with a display, and one or more controller interfaces for coupling with one or more game controllers.

Over the years, different game controllers have been developed which enable a user to interact with the video games by manipulating the various inputs provided on the controller. Typically, the game console will be sold bundled with a generic controller for use with the majority of games compatible with that console. This generic controller may include several directional control buttons and several multi-purpose buttons. These buttons may operate as simple electrical switches indicating one of two states (e.g., pressed or not pressed) or may communicate an analog signal indicating a variety of states (e.g., how far a joystick is moved from center).

A typical home video game system comprises a home television or other video monitor on which the progress of the game, for example a football game, is viewed; a console connected to the television or video monitor for receiving the storage medium on which the computer instructions for a particular game is stored; and a joystick, joy-pad or controller connected to the console and including various switches or other manually operable controls for playing the game. A typical controller includes four directional switches (UP, DOWN, LEFT, RIGHT) for moving a playing piece, for example a quarterback, and a number of play option switches for operating the moves of the playing piece, for example throwing the football or stiff arming an opposing player.

In some cases, specialized controllers for particular games or particular types of games have been developed in order to provide an increased sense of realism for the user. For example, one controller for use with driving simulation games includes a steering wheel, a shifter, and foot-operated pedals. Another controller, for use with first person shooter games, is shaped like a gun and includes a trigger for controlling the firing of a weapon on screen. U.S. Pat. No. 5,259,626 to Ho discloses such a controller for a video game including a mechanism for recording, storing and retrieving a sequence of instructions. Other controllers have been made in the shape of a guitar or drum set for the simulation of playing in a music band. U.S. Pat. No. 7,435,178 to Tam, et al. discloses such a video game controller and method of operation wherein the controller includes a guitar-shaped housing. These video game controllers must be entertaining to use, while being sufficiently durable so as to survive extended use.

There are currently gaming controllers with analog buttons, which allow the controller to sense how much pressure is being applied. Controllers may come in both wired and wireless configurations, where the wireless controllers use batteries or USB ports for charging. Some controllers contain tilt and motion detectors which give the controller the react to a player's physical motion.—Other gaming devices use headset microphone connectors on the front of their controllers.

One of the major problems that many users have with sports games is the current way opposing players can see the plays and further audible plays on the global view of the television or monitor. For a novice player the ability to conceal certain aspects of your game strategy may not be important because of the lack of familiarity with the game and or the lack of gaming ability. However, for moderate to advance players game strategy and the ability to conceal game strategy from the opposing player can mean the difference between winning and losing the game. Further, and especially with the sport, football, the game controller is not designed for the realism of how the actual game is played, as the participants in an actual game do not function with joysticks or game controllers as they currently exist.

Nishino et. al., U.S. Pat. No. 6,540,614, attempts to address this dilemma for gaming users, by providing a game device capable of notifying a player of the timing for observing individual display units without ruining the game-world view. However more is needed, particularly in the area of sporting games, in which many instant decisions are required. By removing the gaming playbook and audible plays from the global television or video monitor to controller monitors that only the individual user can see, the opposing player would not know what play the user is calling. Further, this controller monitor(s) can be placed onto a controller, which adds to the realism of how the game is actually played, such as a sleeve or wristband with plays thereupon for selection in a football game.

### OBJECTIVE OF THE INVENTION

The main objective of the invention is to provide a game controller that has the ability to display select game information in which a player may wish to keep private from opposing players and that more closely resembles the real world play calling methods and the apparatuses used therewith.

### SUMMARY OF THE INVENTION

The invention for achieving the aforementioned objects is a video game peripheral capable of displaying select gaming information that would normally be displayed on a display which is in the view of all players. The invention provides a controller which allows the player to choose their plays from their separate controller(s), and not the world view, providing a competitive advantage to each player, and allowing the player better strategize their approach to the game. The controller's display is not meant to take the place of a television or video monitor, but is meant to be used in conjunction with a television or video monitor. An embodiment construction of the controller comprises, a hand controller that works in conjunction with a sleeve or wristband controller, both of which have display screens, allowing the player to select and operate their team in the game independent of the world view on the television or video monitor. Another embodiment is the sleeve or wristband controller used for allowing the player to select and operate their team in the gaming independent of the world view on the television or video monitor, without the use of any other game controller.

### BRIEF DESCRIPTION OF THE DRAWINGS

FIG. 1 is a perspective view of the gaming device controller with a liquid crystal display (LCD) screen and connective tether.

FIG. 2 is a perspective view of the wristband controller with a display and connective tether.

### DESCRIPTION OF THE PREFERRED EMBODIMENT

Embodiments of the present invention are now explained with reference to the relevant drawings.

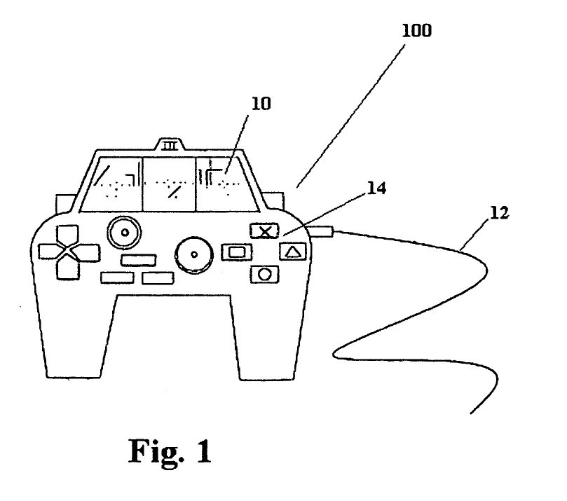

FIG. 1 shows the conceptual diagram of the game controller according to an embodiment. The game device is structured by connecting a game controller 100, display 10, keypad 14, and connective tether 12. This connective tether 12 may be wired or wireless.

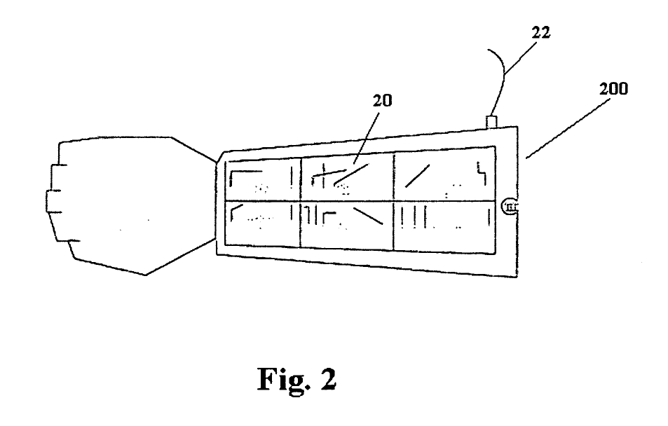

The game controller 100 is a device used to manipulate the games progress. Multiple game controllers 100 can be connected using a plurality of connective tethers 12 to the gaming systems at one time. The display 10 built into the controller 100 is used to display select gaming information that players wishes to keep private from other players. The player uses the keypad 14 to select and or deselect the appropriate game function. The displays 10 of multiple controllers 100 can be linked together thereby showing the same information to players competing on the same team, but not to opposing players. The display 10 will provided visual acknowledgement of the particular function selected by the player so that the player can verify their selection. The game controller 100 is to be used in conjunction with popular gaming consoles. The game controller 100 is meant to take the place of the original controller for the particular gaming console. The gaming controller 100 can also be used along with other gaming controllers, including wristband controller 200 of FIG. 2.

FIG. 2 shows the conceptual diagram of the controller device according to an embodiment of the present invention. The game device is structured by connecting a sleeve or wristband controller 200, a interactive display 20, and a connective tether 22, which may be wired or wireless.

The wristband controller 200 is a device used to display and manipulate certain elements of the games progress, specific to a particular team or player in a game. Multiple wristband controllers 200 can be connected using a plurality of connective tethers 22 to the gaming system at one time. Other wristband controllers 200 may be connected for multiple players on the same team, showing information on interactive display(s) 20, related to the same team, and/or of multiple opposing players on an opposing team, showing information on interactive display(s) 20, related to that opposing team. The interactive display(s) 20 is built into the wristband controller 200. The interactive display(s) 20 allow the user to select by touch or other input means, certain game functions and options that are not shown or visible to opposing players. The interactive display(s) 20 may divided into touch sensitive panes that when pressed selects the particular function or option which appeared on that respective pane. While interactive display(s) 20 of multiple wristband controllers 200 can be linked together thereby showing the same information to players competing on the same team but not to opposing players, the multiple wristband controller(s) 200 linked together for the same team members but not opposing players may also show different information related to and controlling different positions of avatar players on the same team. The interactive display (s) 20 will provided visual acknowledgement of the particular function or option selected by the player so that the player can verify their selection. The display 20 may also allows the player to select an alternative function by undoing the original selection. The wristband controller 200 may to be used in conjunction with popular gaming consoles. The wristband controller 200 may be used along with other gaming controllers, including game controller 100.

I claim:

1. An apparatus, comprising:
at least one video game controller for controlling a video game, said at least one video game controller wearable on a user, controlling said video game;
at least one display attached to said at least one video game controller, said at least one display displaying video game information specific to a user's team and said at least one display selectable to control said video game and wherein said video game information specific to said user's team and said selection is not visible to at least one opposing user;
a communication means for said at least one video game controller for communicating selections of said at least one display to at least one processor for said video game.

2. The apparatus of claim 1, wherein said at least one video game controller wearable on a user is a wristband controller.

3. The apparatus of claim 1, wherein said at least one display attached to said at least one video game controller is segmented into multiple independently selectable areas on said at least one display.

4. The apparatus of claim 1, wherein said communication means is wireless.

5. The apparatus of claim 1, wherein said video game information specific to a user's team is further segmented to said at least one video game controller dependent on said user's role in said video game for said team.

6. The apparatus of clam 5, wherein said video game information specific to a user's role in said video game for a said team, which is selected is further displayed to all users of same said team.

7. An apparatus, comprising:
at least one hand controller, wherein said at least one hand controller comprises at least one display for displaying football video game information;
at least one wearable controller, wherein said at least one wearable controller comprises at least one display for displaying team specific information to a user, said at least one display further comprising at least one selection means for selection of displayed team user specific information, said selection means out of view of an opposing user, and said selection controlling said football video game executed on at least one processor and viewed on at least one primary display; and
at least one communication means, said at least one communication means connecting said at least one wearable controller, said at least one hand controller, said at least one processor and said at least one primary display.

8. The apparatus of claim 7, wherein said wearable controller is the form of a wristband.

9. The apparatus of claim 7, wherein said at least one display attached to said at least one wearable controller is segmented into multiple independently selectable areas on said at least one display.

10. The apparatus of claim 7, wherein said at least one connective means is wireless.

11. The apparatus of claim 7, wherein said team user specific information is further segmented to said at least one wearable controller dependent on said user's role in said football video game for said team.

12. An apparatus, comprising:
at least one video game controller for controlling a video game;
at least one wearable video game controller for controlling said video game;
at least one display attached to said at least one wearable video game controller, said at least one display displaying video game information specific to a user's team and said at least one display selectable to control said video game and wherein said video game information specific to said user's team and said selection is not visible to at least one opposing user;
a communication means between said at least one video game controller, said at least one wearable video game controller for communicating selections of said at least one display to at least one processor for said video game.

13. The apparatus of claim 12, wherein said wearable controller is the form of a wristband.

14. The apparatus of claim 12, wherein said at least one display attached to said at least one wearable controller is segmented into multiple independently selectable areas on said at least one display.

15. The apparatus of claim 12, wherein said at least one connective means is wireless.

16. The apparatus of claim 12, wherein said team user specific information is further segmented to said at least one wearable controller dependent on said user's role in said football video game for said team.
